(19) United States
(12) Patent Application Publication
(10) Pub. No.: US 2026/0159304 A1
(43) Pub. Date: Jun. 11, 2026

(54) TRIGGER PACKAGING BOTTLE WITH SEALED STRUCTURE

(71) Applicant: Guangzhou Hongying Technology Co., Ltd., Guangzhou (CN)

(72) Inventors: Zemin Liu, Guangzhou (CN); Hu Lin, Shenzhen (CN); Huanyu Liu, Guangzhou (CN)

(21) Appl. No.: 19/408,474

(22) Filed: Dec. 4, 2025

(30) Foreign Application Priority Data
Dec. 5, 2024 (CN) 202422993668.2

(51) Int. Cl. B65D 83/76

(52) U.S. Cl. CPC B65D 83/76

(57) ABSTRACT

A trigger packaging bottle with a sealing structure is provided, which includes a bottle body, a movable sealing element provided at a bottom of the bottle body, a bottle top fastener clamped at a top opening of the bottle body, a pressure balance hole provided at the bottom of the bottle body, a flow channel hole provided at a bottom of the bottle top fastener, an upside-down bowl shaped elastic component provided in an inner cavity of the bottle top fastener, and a contact cylinder coaxially provided in an inner cavity of the upside-down bowl shaped elastic component. A top thread of the bottle top fastener is connected to a pressing head, and a top of the pressing head is rotatably connected to a trigger-function component. A pressing cylinder is provided at a bottom of an inner cavity of the pressing head.

### CROSS-REFERENCE TO RELATED APPLICATIONS

This application claims priority to Chinese Patent Application No. 202422993668.2, filed on Dec. 5, 2024, which is hereby incorporated by reference in its entirety.

### TECHNICAL FIELD

The present disclosure relates to the field of packaging bottle technologies, and in particular, to a trigger packaging bottle with a sealing structure.

### BACKGROUND

Tubes (plastic tubes), plastic bottles, wide mouthed plastic cans, and glass cans are commonly used to hold materials, milk, cream, and other daily chemical products, as well as sauce-based foods, toothpaste, and other oral cleaning products. Currently, aluminum and plastic laminated tubes and plastic tubes are commonly used. The usual way to open the packaging bottle cap in existing technology includes twisting it open, rotating the cap off the bottle body, taking out the cream or milk from the bottle, or using a pressing head that presses a top of the bottle to extract the material from the bottle. However, existing pressing bottles do not have an additional one-way sealing structure on the top, which can easily lead to pumping without product dispensing and unstable discharge.

### SUMMARY

The purpose of the present disclosure is to propose a trigger packaging bottle with a sealing structure to solve shortcomings of the existing technology.

In order to achieve the above objectives, the present disclosure adopts the following technical solution.

A trigger packaging bottle with a sealing structure, including a bottle body, where a movable sealing element is slidably provided at a bottom of the bottle body, a bottle top fastener is clamped at a top opening of the bottle body, an air pressure balance hole is provided at the bottom of the bottle body, a flow channel hole is provided at a bottom of the bottle top fastener, an upside-down bowl shaped elastic component is provided in an inner cavity of the bottle top fastener, a contact cylinder is coaxially provided in an inner cavity of the upside-down bowl shaped elastic component, and a top thread of the bottle top fastener is connected to a pressing head; a top of the pressing head is rotatably connected to a trigger-function component, and a pressing cylinder is provided at a bottom of the inner cavity of the pressing head; a bottom of the pressing cylinder is inserted into and communicated with the contact cylinder.

In some embodiments of the present disclosure, an outer wall of the bottle top fastener is integrally formed with a plurality of sealing rings, and the sealing rings are pressed against an inner wall of an upper opening of the bottle body.

In some embodiments of the present disclosure, a nozzle is provided at the top of the pressing head, and the nozzle is communicated to the pressing cylinder.

In some embodiments of the present disclosure, a second one-way valve is provided in the inner cavity of the bottle top fastener, and the second one-way valve is clamped between the bottle top fastener and the contact cylinder; a first one-way valve is provided in an inner cavity of the contact cylinder, and the first one-way valve is clamped between the pressing cylinder and the contact cylinder.

In some embodiments of the present disclosure, an outer wall of the pressing head is provided with a sealing outer edge, and the sealing outer edge is clamped between a top cover and the bottle body; the outer wall of the pressing head is provided with a plurality of clamp slots, and an inner wall of the top cover is provided with protrusions that are configured to be inserted into the clamp slots.

The present disclosure proposes a trigger packaging bottle with a sealing structure, which has the following beneficial effects.
1. Providing the trigger-function component to easily remove the material inside the bottle body by simply pressing the trigger-function component, which is practical and convenient.
2. The first and second one-way valves are used in combination with the upside-down bowl shaped elastic component to enhance the sealing performance of the entire packaging bottle, reduce the situation of empty pumps, and ensure more stable discharge.

### BRIEF DESCRIPTION OF DRAWINGS

FIG. 1 is a schematic structural diagram of a trigger packaging bottle with a sealing structure proposed by the present disclosure.

FIG. 2 is an A-A cross-sectional view of the trigger packaging bottle with a sealing structure proposed by the present disclosure.

FIG. 3 is an exploded view of the trigger packaging bottle with a sealing structure proposed by the present disclosure.

FIG. 4 is a schematic structural diagram of a pressing head of the trigger packaging bottle with a sealing structure proposed by the present disclosure.

FIG. 5 is an explosion diagram of the pressing head of the trigger packaging bottle with a sealing structure proposed by the present disclosure.

Numeral reference: 1—top cover, 2—trigger-function component, 3—pressing head, 4—upside-down bowl shaped elastic component, 5—first one-way valve, 6—second one-way valve, 7—bottle top fastener, 8—movable sealing element, 9—bottle body, 10—pressing cylinder, 11—contact cylinder, 12—sealing ring, 13—flow channel hole, 14—sealing outer edge, 15—clamp slot, 16—air pressure balance hole.

### DESCRIPTION OF EMBODIMENTS

The following will provide a clear and complete description of the technical solution in the embodiments of the present disclosure, based on the accompanying drawings. Obviously, the described embodiments are only a part of the embodiments of the present disclosure, not all of them.

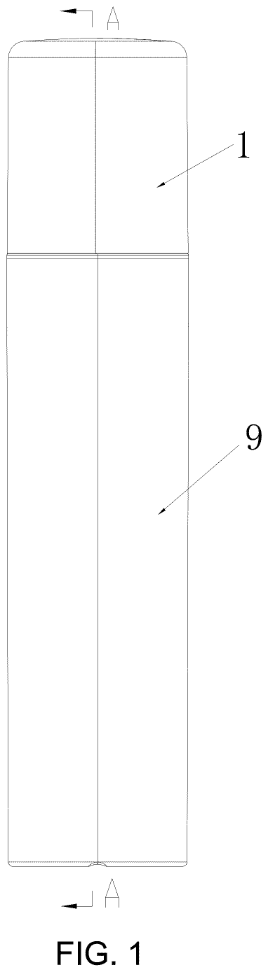

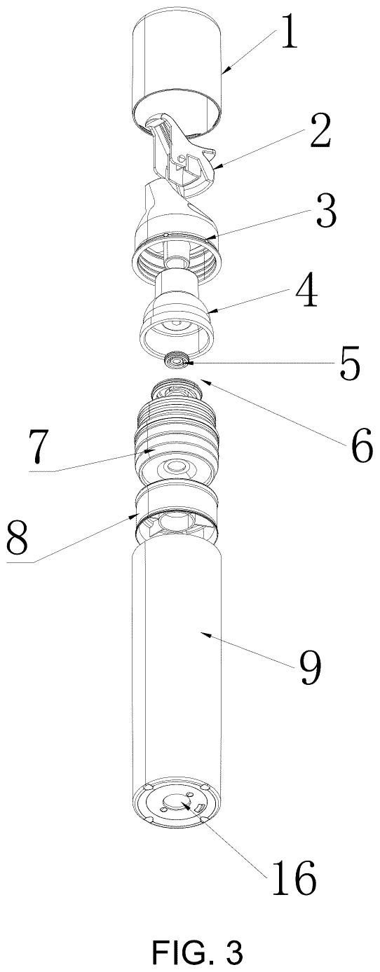

Referring to FIGS. 1, 3, and 5, a trigger packaging bottle with a sealing structure includes a bottle body 9, a movable sealing element 8 slidably provided at a bottom of the bottle body 9, a bottle top fastener 7 clamped at a top opening of the bottle body 9, an air pressure balance hole 16 provided at the bottom of the bottle body 9, a flow channel hole 13 provided at a bottom of the bottle top fastener 7, and an upside-down bowl shaped elastic component 4 provided in an inner cavity of the bottle top fastener 7. The contraction or expansion of the upside-down bowl shaped elastic component 4 plays a role in suctioning internal material of the bottle body 9. A contact cylinder 11 is coaxially provided in an inner cavity of the upside-down bowl shaped elastic component 4. A top thread of the bottle top fastener 7 is connected to the pressing head 3, and a top of the pressing head 3 is rotatably connected to a trigger-function component 2. A bottom of an inner cavity of the pressing head 3 is provided with a pressing cylinder 10, a bottom of the pressing cylinder 10 is inserted into and communicated with the contact cylinder 11.

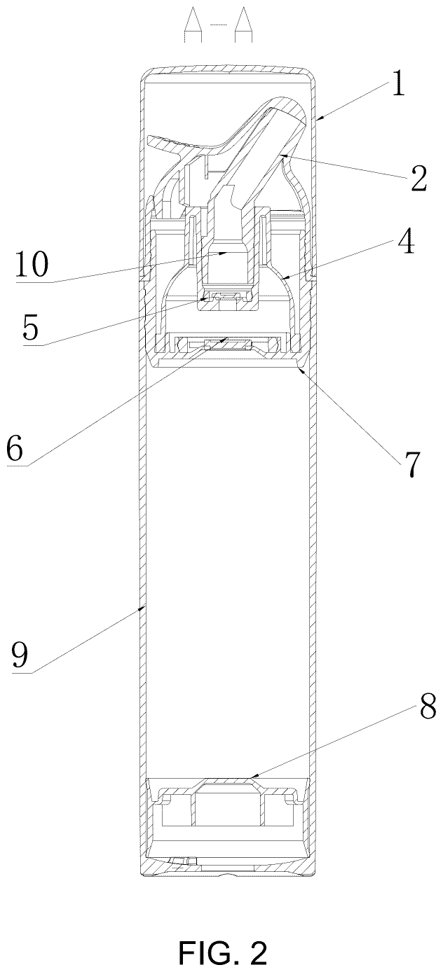

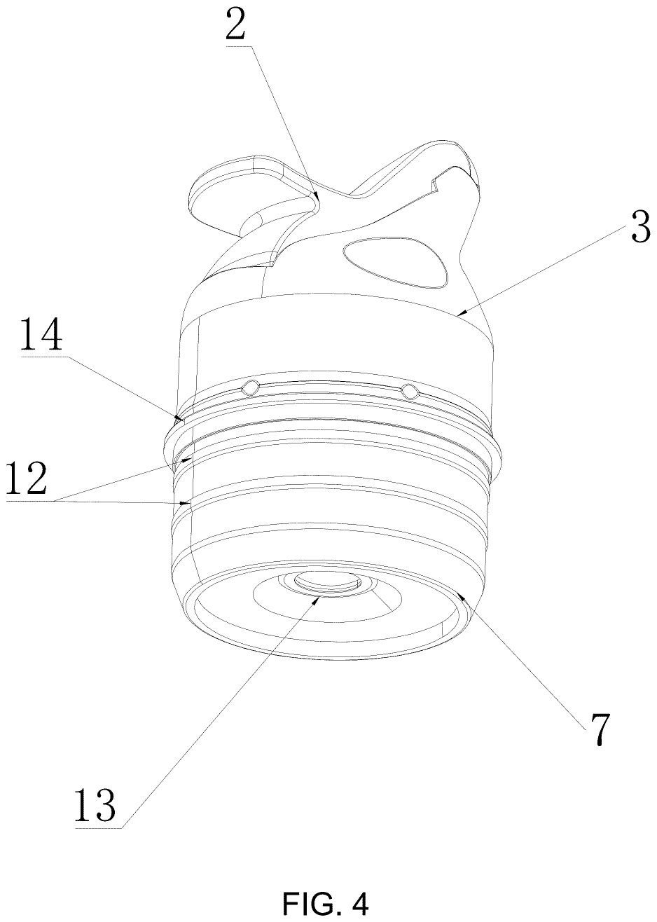

Referring to FIGS. 2, 3, and 4, an outer wall of the bottle top fastener 7 is integrally formed with a plurality of sealing rings 12. The sealing rings 12 are in contact with an inner wall of an upper opening of the bottle body 9, and play a sealing role at the upper opening of the bottle body 9. A nozzle is provided at the top of the pressing head 3, and the nozzle is communicated to the pressing cylinder 10.

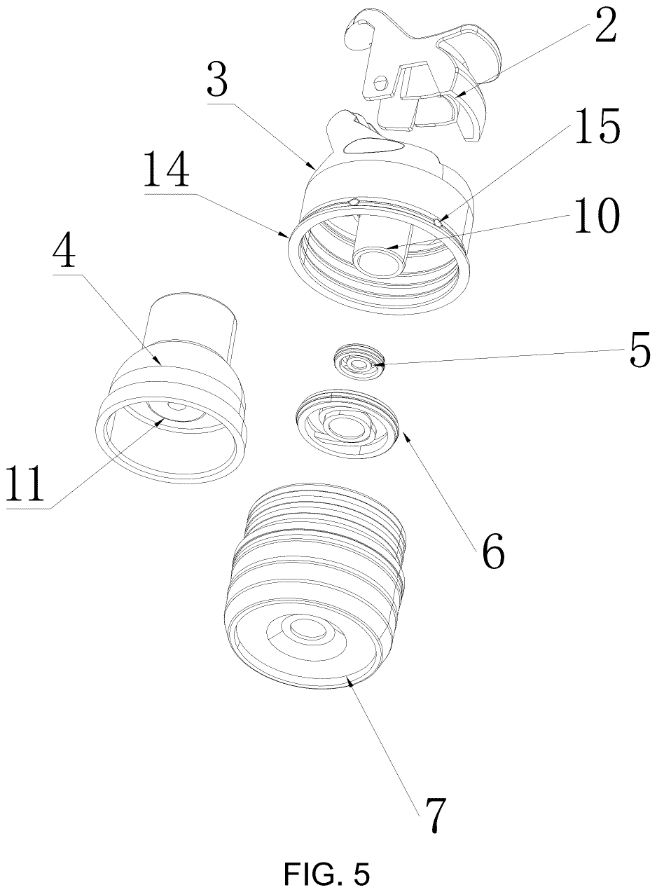

Referring to FIG. 5, a second one-way valve 6 is provided in the inner cavity of the bottle top fastener 7, and the second one-way valve 6 is clamped between the bottle top fastener 7 and the contact cylinder 11. A first one-way valve 5 is provided in an inner cavity of the contact cylinder 11, and the first one-way valve 5 is clamped between the pressing cylinder 10 and the contact cylinder 11. An outer wall of the pressing head 3 is provided with a sealing outer edge 14, and the sealing outer edge 14 is clamped between a top cover 1 and the bottle body 9. An outer wall of the pressing head 3 is provided with a plurality of clamp slots 15, and an inner wall of the top cover 1 is provided with protrusions that can be inserted into the clamp slots 15. The clamp slots 15 are matched with the protrusions to enable the top cover 1 to be clamped onto the pressing head 3.

Working principle: when taking material inside the bottle body 9, the trigger-function component 2 is pressed and the pressing cylinder 10 is pushed to move the contact cylinder 11 downwards. At this time, the upside-down bowl shaped elastic component 4 is deformed under pressure, and the second one-way valve 6 is in a sealing state to prevent the material inside the upside-down bowl shaped elastic component 4 from flowing back into the bottle body 9. The first one-way valve 5 is in an open state. When pressing, the material inside the upside-down bowl shaped elastic component 4 is squeezed by the first one-way valve 5 into an interior of the pressing cylinder 10 and then discharged from the opening of the pressing head 3. After releasing the trigger-function component 2, the upside-down bowl shaped elastic component 4 starts to rebound. The first one-way valve 5 prevents the material inside the pressing cylinder 10 from flowing back, and negative pressure is formed inside the upside-down bowl shaped elastic component 4. External atmospheric pressure pushes the movable sealing element 8 upward through the air pressure balance hole 16, and when the movable sealing element 8 moves up, the pressure on the inner wall of bottle body 9 is increased to allow the material to enter the upside-down bowl shaped elastic component 4 through the second one-way valve 6.

The above is only preferred specific implementation mode of the present disclosure, but the protection scope of the present disclosure is not limited to this. Any technical personnel familiar with the technical field should be included in the protection scope of the present disclosure by equivalent substitution or modification based on the technical solution and concept disclosed in the present disclosure.

What is claimed is:

1. A trigger packaging bottle with a sealing structure, comprising a bottle body,
wherein a movable sealing element is slidably provided at a bottom of the bottle body, a bottle top fastener is clamped at a top opening of the bottle body, an air pressure balance hole is provided at the bottom of the bottle body, a flow channel hole is provided at a bottom of the bottle top fastener, an upside-down bowl shaped elastic component is provided in an inner cavity of the bottle top fastener, a contact cylinder is coaxially provided in an inner cavity of the upside-down bowl shaped elastic component, and a top thread of the bottle top fastener is connected to a pressing head;
a top of the pressing head is rotatably connected to a trigger-function component, and a pressing cylinder is provided at a bottom of the inner cavity of the pressing head; a bottom of the pressing cylinder is inserted into and communicated with the contact cylinder.

2. The trigger packaging bottle with a sealing structure according to claim 1, wherein an outer wall of the bottle top fastener is integrally formed with a plurality of sealing rings, and the sealing rings are pressed against an inner wall of an upper opening of the bottle body.

3. The trigger packaging bottle with a sealing structure according to claim 1, wherein a nozzle is provided at the top of the pressing head, and the nozzle is communicated to the pressing cylinder.

4. The trigger packaging bottle with a sealing structure according to claim 1, wherein a second one-way valve is provided in the inner cavity of the bottle top fastener, and the second one-way valve is clamped between the bottle top fastener and the contact cylinder;
a first one-way valve is provided in an inner cavity of the contact cylinder, and the first one-way valve is clamped between the pressing cylinder and the contact cylinder.

5. The trigger packaging bottle with a sealing structure according to claim 1, wherein an outer wall of the pressing head is provided with a sealing outer edge, and the sealing outer edge is clamped between a top cover and the bottle body;
the outer wall of the pressing head is provided with a plurality of clamp slots, and an inner wall of the top cover is provided with protrusions that are configured to be inserted into the clamp slots.
